(19) United States
(12) Patent Application Publication
(10) Pub. No.: US 2020/0247426 A1
(43) Pub. Date: Aug. 6, 2020

(54) SYSTEMS AND METHODS FOR AUTOMATICALLY ADJUSTING A VEHICLE DRIVING MODE AND DISPLAYING THE DRIVING MODE

(71) Applicant: Toyota Motor Engineering & Manufacturing North America, Inc., Plano, TX (US)

(72) Inventors: John Charles Rafferty, Dexter, MI (US); Lou M. Pope, Ypsilanti, MI (US); Clinton J. Williams, Saline, MI (US)

(73) Assignee: Toyota Motor Engineering & Manufacturing North America, Inc., Plano, TX (US)

(21) Appl. No.: 16/263,896

(22) Filed: Jan. 31, 2019

(51) Int. Cl. B60W 50/08; B60W 50/14; G08G 1/0967; B60K 35/00

(52) U.S. Cl. CPC B60W 50/082; B60W 50/14; B60W 2050/0077; B60K 35/00; G08G 1/096725

(57) ABSTRACT

A system includes a processor, and a memory module communicatively coupled to the processor, the memory module including one or more processor-readable instructions. When executed, the one or more processor-readable instructions cause the processor to receive a driving mode input signal, the driving mode input signal corresponding to one or more driving conditions, determine a corresponding driving mode based on the driving mode input signal, adjust a first driving mode to the corresponding driving mode, and generate a notification of the adjustment from the first driving mode to the corresponding driving mode.

### TECHNICAL FIELD

The present specification generally relates to systems and methods for automatically adjusting a vehicle driving mode, and more specifically, to systems and methods for automatically adjusting a vehicle driving mode based on detected road characteristics.

### BACKGROUND

Vehicles may operate on various surfaces and under various weather conditions which may cause vehicle systems to perform differently based on the surface on which the vehicle is operating. It may be desirable to adjust a driving mode automatically based on a driving mode input signal, for example, a visual sensor signal that may determine one or more characteristics of the surface on which the vehicle operates. Moreover, it may be desirable to inform a user when such an adjustment occurs. Accordingly, systems and methods for automatically adjusting a vehicle driving mode and a display based on a driving mode input signal may be desired.

### SUMMARY

In one embodiment, a system includes a processor, and a memory module communicatively coupled to the processor, the memory module including one or more processor-readable instructions. When executed, the one or more processor-readable instructions cause the processor to receive a driving mode input signal, the driving mode input signal corresponding to one or more driving conditions, determine a corresponding driving mode based on the driving mode input signal, adjust a first driving mode to the corresponding driving mode, and generate a notification of the adjustment from the first driving mode to the corresponding driving mode.

In another embodiment, a vehicle includes a system including one or more vehicle-mounted sensors configured to generate a sensor signal that is based on one or more sensed driving conditions, a processor, and a memory module communicatively coupled to the processor, the memory module including one or more processor-readable instructions. When executed, the one or more processor-readable instructions cause the processor to receive a driving mode input signal, the driving mode input signal corresponding to one or more driving conditions and based on the sensor signal, determine a corresponding driving mode based on the driving mode input signal, adjust a first driving mode to the corresponding driving mode, and generate a notification of the adjustment from the first driving mode to the corresponding driving mode.

In yet another embodiment, a method of adjusting a vehicle driving mode to a corresponding driving mode includes receiving, by a processor, a driving mode input signal, the driving mode input signal corresponding to one or more driving conditions, determining, by the processor, a corresponding driving mode based on the driving mode input signal, adjusting, by the processor, a first driving mode to the corresponding driving mode, and generating, by the processor, a notification of the adjustment from the first driving mode to the corresponding driving mode.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative interior of a vehicle that includes a system for adapting a driving mode and a driving mode display, according to one or more embodiments shown and described herein;

FIG. 2 depicts illustrative internal hardware components of the system of FIG. 1, according to one or more embodiments, shown and described herein;

FIG. 3 depicts a flow diagram of an illustrative method for adapting a driving mode of a vehicle based on a driving mode input signal; according to one or more embodiments shown and described herein;

FIG. 4 depicts a graphical user interface of the vehicle of FIG. 1, the display indicating a first example operating mode, according to one or more embodiments described herein; and

FIG. 5 depicts the graphical user interface of FIG. 4, the display indicating a second example operating mode, according to one or more embodiments shown and described herein.

### DETAILED DESCRIPTION

The present disclosure relates to systems and methods for automatically adjusting a vehicle driving mode and displaying the driving mode. A vehicle driving mode may refer to a group of one or more vehicle settings that, when affected, may change an operating characteristic of a vehicle. For example, a vehicle driving mode may refer to whether the vehicle is operating in two- or four-wheel-drive, whether a traction control system is engaged, whether the transmission is operating in an automatic or manual mode, and the like. A vehicle driving mode may be changed, for example, based on characteristics of the surface on which the vehicle is operating. Other reasons for changing a vehicle operating mode, include, but are not limited to, weather conditions, vehicle systems status, vehicle efficiency requirements, and the like. Vehicles may operate on many different types of surfaces and may change from one surface to another quickly, leaving vehicle operators with little time to adjust vehicle settings manually. Moreover, having to adjust vehicle settings manually may distract an operators attention.

Vehicle-borne sensors may be capable of detecting surface conditions, weather conditions, and other conditions of the operating environment automatically. Additionally, vehicles may include one or more systems for receiving information regarding the environmental operating conditions from an external source, such as a cloud network or other vehicles. For example, weather reports, roadway surface characteristics, traffic reports, construction reports, and other information may be available to on-board systems via a connection with an external network and/or node. This information may be utilized to adjust vehicle operating mode settings. Additionally, because users may desire to know when particular vehicle settings have been updated, vehicle displays may be adapted (e.g., using the generation of notifications, or the like) to inform users when changes have been made to vehicle settings. Notification of vehicle settings changes may enable a user to accept or deny the change, or in instances in which the change occurred automatically, to reset to a previous setting or group of settings.

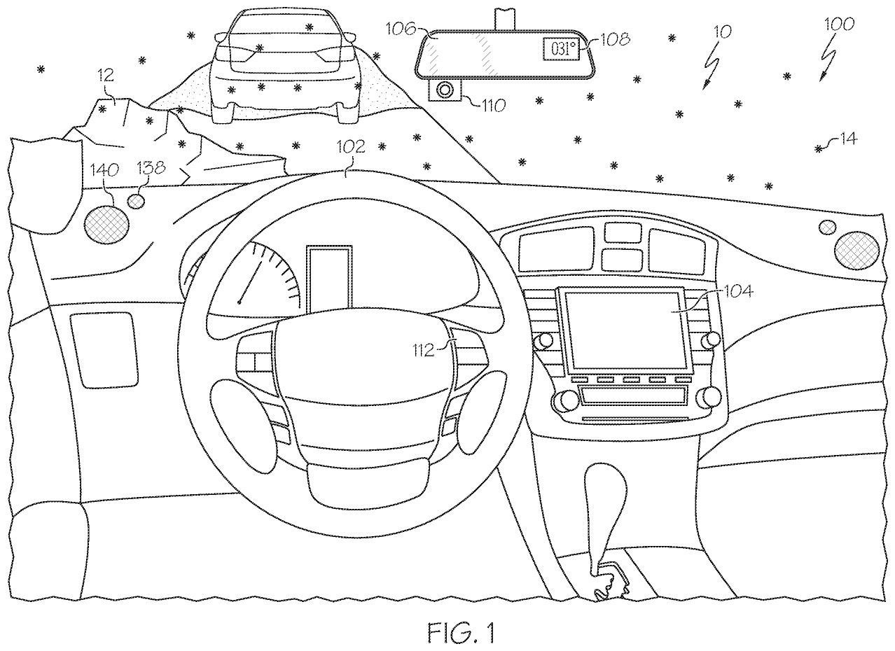

Referring now to FIG. 1, an interior of a vehicle 10 is shown. The vehicle 10 shown in FIG. 1 is an example embodiment including an exemplary system 100 for adapting a driving mode based on a driving mode input signal. The vehicle 10 includes a steering wheel 102, a display 104, a rear view mirror 106 that may include a temperature display 108 that outputs a sensed temperature (e.g., sensed by a thermometer), and a camera 110 that may image an outside and/or an inside of the vehicle 10. The vehicle 10 may also include a microphone 138 and a speaker 140 for receiving an audio input and generating an audio output, respectively. The vehicle 10 includes an input device 112 that a user (e.g., a driver, a passenger, or the like) may use to change one or more vehicle settings and/or to respond to one or more queries generated by systems of the vehicle 10 as described in greater detail herein.

The vehicle 10 may be configured to adjust automatically between various operating modes. For example, the vehicle 10 may include one or more control modules or electronic control units (ECU) that may connect to other various systems via a bus (e.g., a CAN bus) and may affect one or more automatic adjustments between operating modes as will be described in greater detail herein. The various driving modes may encompass one or more vehicle operation characteristics. For example, the vehicle may actively power or disengage one or more wheels (e.g., an adjustment to a four-wheel drive mode from a two-wheel drive mode and vice-versa), may initiate one or systems (e.g., a traction control system, a vehicle stability control system, etc.), may activate one or more dampers, may activate one or more cooling systems (e.g., an oil cooling system, a transmission fluid cooling system, and the like), and make other changes to vehicle operating characteristics. In some embodiments, aspects of the operating modes include the operation of electronic and/or mechanical equipment that may track the position, the orientation, and/or the movement of the vehicle. For example, aspects of the operating modes may include GPS systems and navigation modules, accelerometers, clinometers, and the like.

In the particular example embodiment depicted in FIG. 1, the vehicle 10 is operating in an environment such that it is positioned before an obstacle 12 (a rock) and precipitation 14 (snow) is falling. The obstacle 12 and the precipitation 14 may be detected as in the path of the vehicle 10 by the systems onboard the vehicle 10. For example, the camera 110 may detect the obstacle 12. Some embodiments may include other sensors such as, for example, lidar, radar, sonar, and the like and these sensors may be used to detect the obstacle 12. Based on the detection externally detected objects such as the obstacle 12, the precipitation 14, and the like, the vehicle 10 may automatically adjust an operating mode based on the detection. For example, the vehicle may activate or deactivate the traction control system based on the presence of the obstacle 12. Additionally, the vehicle 10 may determine the presence of external objects such as the obstacle 12 or precipitation 14 based on an input from an external system (e.g., a cloud-based weather service, vehicle-to-vehicle connection, and the like). As described in greater detail herein, a system onboard the vehicle 10 may receive a driving mode input signal based on objects/environmental conditions. The system may determine a corresponding driving mode based on the driving mode input signal and may adjust a current driving mode to the corresponding driving mode. Further, the system may generate a notification of the adjustment from the current driving mode to the corresponding driving mode.

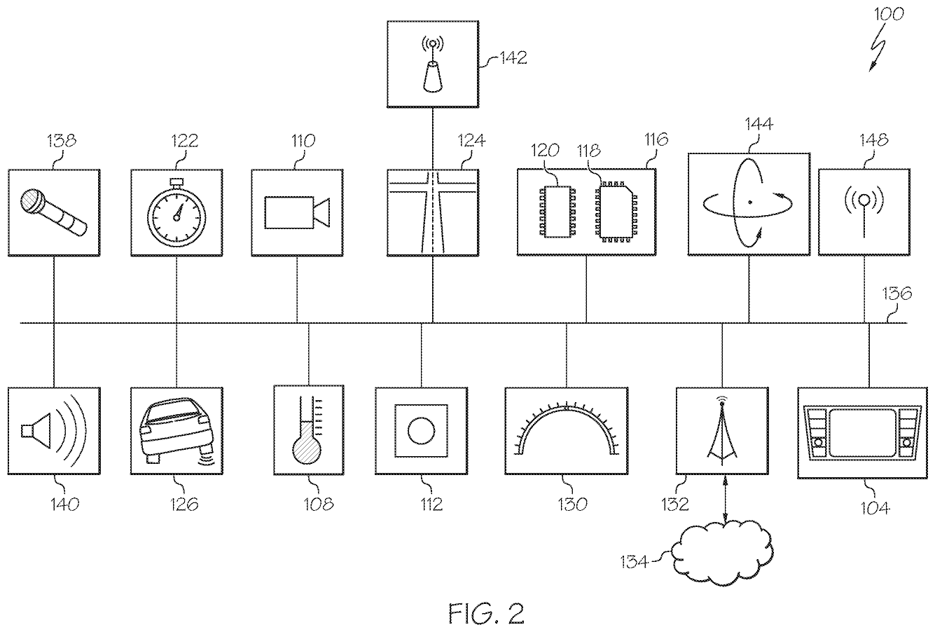

FIG. 2 depicts internal hardware components of a system 100 that are incorporated in a vehicle, such as the vehicle 10 of FIG. 1, to determine a corresponding driving mode and adjust one or more vehicle systems to the corresponding driving mode and to indicate such adjustment. The system 100 includes an electronic control unit (ECU) 116 including a processor 118 and a memory module 120. Embodiments of the system 100 may include a pressure sensor 122 configured to determine a tire pressure of one or more tires of the vehicle 10, the camera 110, and a navigation module 124 which may be configured to receive a signal from position locating hardware 142 and provide information to a user through a graphical user interface that may be displayed on the display 104. Still referring to FIG. 2, embodiments of the system 100 may further include a traction control system 126, the temperature detector 108, a clinometer 130, the microphone 138, the speaker 140, an accelerometer 144, an external sensor 148, and network interface hardware 132 that may connect to an external network 134, and a bus 136 that may communicatively couple various components of the system 100.

As noted above, the system 100 includes the ECU 116. The ECU 116 includes the processor 118. It is to be understood that the system 100 may include one or more processors similar to the processor 118. The processor 118 may be any device capable of executing processor-readable instructions. Accordingly, the processor 118 may be a controller, an integrated circuit, a microchip, a computer, or any other computing device. The processor 118 is communicatively coupled to the other components of the system 100 via the bus 136. Accordingly, the bus 136 may communicatively couple any number of processors with one another, and allow the modules coupled to the bus 136 to operate in a distributed computing environment. Specifically, each of the modules may operate as a node that may send and/or receive data.

As noted above, the ECU 116 includes the memory module 120. The memory module 120 is coupled to the bus 136 and communicatively coupled to the processor 118. The memory module 120 may comprise RAM, ROM, flash memories, hard drives, or any device capable of storing one or more processor-readable instructions such that the processor-readable instructions may be accessed and executed by the processor 118. The processor-readable instructions may comprise logic or algorithm(s) written in any programming language of any generation (e.g., 1GL, 2GL, 3GL, 4GL, or 5GL) such as, for example, machine language that may be directly executed by the processor 118, or assembly language, object-oriented programming (OOP), scripting languages, microcode, etc., that may be compiled or assembled into processor-readable instructions and stored on the memory module 120. In some embodiments, the processor-readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The camera 110 is coupled to the bus 136. It is to be understood that the system 100 may include one or more cameras 110 and that, while FIG. 1 shows only a single camera 110 that is attached to a rear view mirror, one or more cameras could be located at various positions within or on the outside of the vehicle 10 without limitation. The camera 110 is arranged to obtain images inside the vehicle 10 and outside the vehicle 10. Referring again to FIG. 2, the camera 110 is communicatively coupled to the processor 118 via the bus 136. Each camera 110 may be any device having an array of sensing devices capable of detecting radiation in an ultraviolet wavelength band, a visible light wavelength band, or an infrared wavelength band. Each camera 110 may have any resolution. The camera 110 may include an omni-directional camera, or a panoramic camera. In some embodiments, one or more optical components, such as a mirror, fish-eye lens, or any other type of lens may be optically coupled to the camera 110. The camera 110 may be located inside the vehicle 10 to capture image data of the occupants in the vehicle 10 and their gestures, expressions, etc. In some embodiments, the image data may be used to make one or more changes to the system 100 as described herein. For example, users of the vehicle may confirm one or more changes to vehicle settings by nodding, pointing, gesturing, etc. and such movements or gestures may be captured by the camera 110 and processed according to image or pattern recognition algorithms as described herein to affect one or more changes to vehicle systems. The camera 110 may capture image data outside the vehicle based on the external objects or surroundings of the vehicle. For example, with brief reference to FIG. 1, the camera 110 may capture one or more images of the obstacle 12 and/or the precipitation 14 for processing in order that the obstacle 12 and the precipitation 14 may be identified.

Referring again to FIG. 2, in operation, the camera 110 captures image data and communicates the image data to one or more components communicatively coupled to the bus 136. For example, the image data may be received by the processor 118, which may process the image data using one or more image processing algorithms. Any known or yet-to-be developed video and image processing algorithms may be applied to the image data in order to identify an item, situation, or person. Example video and image processing algorithms include, but are not limited to, kernel-based tracking (such as, for example, mean-shift tracking) and contour processing algorithms. In general, video and image processing algorithms may detect objects and movement from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms. In some embodiments, the processor 118 may be configured to use visual data captured by the camera 110 to recognize gestures, features, or other aspects of user (e.g., passengers) behavior and may use such recognition as an input signal. One or more vehicle settings may be updated based on such a visual signal.

Some embodiments may be configured to determine an identity of the occupants of the vehicle and may base various facets of system functionality on determined identities. For example, in some embodiments, at least some portion of a vantage of the camera 110 may include an interior of the vehicle 10 and the camera 110 may generate image data including images of the occupants of the vehicle 10. This image data may be processed to determine an identity of the occupant and only gestures performed by recognized or identified users may be recognized or used by the system 100 to initiate or accept changes to vehicle status. In embodiments, camera-captured biometrics (facial recognition technology, finger print scanning, eye scanning, etc.) may be utilized to identify and/or authenticate the identity of an occupant of the vehicle. For example, images of the user may be captured by the camera 110 and stored (e.g., in the memory module 120) and the stored images may be compared to subsequent images to identify the user. In some embodiments, an image on a photo identification card, such as a driver's license or a state-issued identification card may be used as an initial image to identify a user and/or other passengers of the vehicle 10.

As noted above, the system 100 comprises the microphone 138 for transforming acoustic vibrations received by the microphone 138 into a speech input signal. The microphone 138 is coupled to the bus 136 and communicatively coupled to the processor 118. The processor 118 may process speech and other input signals received from the microphone 138 and/or extract information from the signals. The microphone 138 may be used to record audio data from the user and/or other passengers of the vehicle 10. Such recorded data may be used as a basis to adjust one or more vehicle settings and/or to identify the user and/or other passengers of the vehicle 10. For example, the user's voice may be recorded and stored (e.g., in the memory module 120) as a marker to identify the user in subsequent audio recordings captured by the system 100.

As noted above, the system 100 includes the speaker 140 for transforming data signals from the system 100 into mechanical vibrations, such as in order to output audible prompts or audible information from the system 100. The speaker 140 is coupled to the bus 136 and communicatively coupled to the processor 118. The speaker 140 may output notifications in the form of dings, chimes, bells, jingles, or the like to notify a user of, for example, one or more adjustments in settings or requests for permission to update one or more settings. In some embodiments, the system 100 may be configured to generate recognizable speech patterns in a user-recognized language (e.g., English, Spanish, or the like) and may present information to vehicle occupants in recognized speech patterns. That is, the system 100 may ask questions of the user in understandable audible language.

The system 100 comprises the display 104 for providing visual output such as, for example, messages and other information, entertainment, maps, navigation, information, or a combination thereof. The display 104 is communicatively coupled to the processor 118 via the bus 136. Accordingly, the bus 136 communicatively couples the display 104 to other modules of the system 100. The display 104 may include any medium capable of transmitting an optical output such as, for example, a cathode ray tube, light emitting diodes, a liquid crystal display, a plasma display, a volumetric display, or the like. Moreover, the display 104 may be a touchscreen that, in addition to providing optical information, detects the presence and location of a tactile input upon a surface of or adjacent to the display. Accordingly, each display 104 may receive mechanical input directly upon the optical output provided by the display 104. Additionally, it is noted that the display 104 may include at least one processor similar to the processor 118 and one memory module similar to the memory module 120. While the system 100 includes a display 104 in the depicted embodiment, the system 100 may include multiple displays.

As noted above, the system 100 optionally includes a navigation module 124 which may include the position locating hardware 142. The navigation module 124 may be configured to obtain and update positional information of the vehicle 10 and to display such information to one or more users of the vehicle 10 (e.g., via the display 104). The navigation module 124 may be able to obtain and update positional information based on geographical coordinates (e.g., latitudes and longitudes), or via electronic navigation where the navigation module 124 electronically receives positional information through satellites. In certain embodiments, the navigation module 124 may include or be coupled to a GPS system.

The position locating hardware 142 may be coupled to the bus 136 such that the bus 136 communicatively couples the position locating hardware 142 to other modules of the system 100. The position locating hardware 142 is configured to receive signals from global positioning system satellites or other position locating devices (e.g., cell network towers, GPS transponders, etc.). Specifically, in one embodiment, the position locating hardware 142 includes one or more conductive elements that interact with electromagnetic signals transmitted by global positioning system satellites. The received signal is transformed into a data signal indicative of the location (e.g., latitude and longitude) of the position locating hardware 142 or an object positioned near the position locating hardware 142, by the processor 118. In embodiments where the system 100 is coupled to a vehicle, the processor 118 may execute machine readable instructions to transform the global positioning satellite signals or other signals received by the position locating hardware 142 into data indicative of the current location of the vehicle 10. While the system 100 includes the position locating hardware 142 in the embodiment depicted in FIG. 2, the system 100 may not include the position locating hardware 142 in other embodiments, such as embodiments in which the system 100 does not utilize global positioning satellite information or embodiments in which the system 100 obtains global positioning satellite information from a mobile device or other external device or network.

Additionally, the system 100 includes the input device 112 coupled to the bus 136 such that the bus 136 communicatively couples the input device 112 to other modules of the system 100. The input device 112 may be any device capable of transforming mechanical, optical, or electrical signals into a data signal capable of being transmitted via the bus 136. The input device 112 may include any number of movable objects that each transforms physical motion into a data signal that may be transmitted over the bus 136 such as, for example, a button, a switch, a knob, a microphone, or the like. While the input device 112 is depicted in FIGS. 1 and 2 as separate tactile input hardware, it is to be understood that in some embodiments, the input device 112 is a touch screen and the display 104 and the input device 112 may be combined as a single module and operate as an audio head unit or an infotainment system. However, it is noted that the display 104 and the input device 112 may be separate from one another and may each operate as a single module by exchanging signals via the bus 136. While the system 100 includes input device 112 in the embodiment depicted in FIGS. 1 and 2, the system 100 may not include input device 112 in other embodiments, such as embodiments that only include the display 104.

The external sensor 148 may be one or more of a LIDAR, radar, or sonar system that may send one or more waves of energy externally from the vehicle 10 and receives a reflected wave using one or more of a LIDAR, radar, or sonar sensor. The external sensor 148 may operate in addition to the camera 110. In embodiments having a LIDAR sensor, the LIDAR sensor may be coupled to the processor 118 via the bus 132. The LIDAR sensor is a system capable of using pulsed light (e.g., laser light) to measure distances from the LIDAR sensor to objects that reflect the pulsed light. A LIDAR sensor may be made as one or more solid-state devices with few or no moving parts, including those configured as optical phased array devices where prism-like operation may permit a wide field-of-view without the weight and size complexities associated with a traditional rotating LIDAR sensors. The LIDAR sensor may be particularly suited to measuring time-of-flight, which in turn can be correlated to distance measurements with objects that are within a field-of-view of the LIDAR sensor. By calculating the difference in return time of the various wavelengths of the pulsed laser light emitted by the LIDAR sensor a digital 3-D representation of a target or environment may be generated. The pulsed laser light emitted by the LIDAR sensor may in one form be operated in or near the infrared range of the electromagnetic spectrum (e.g., about 905 nanometers). The LIDAR sensor may be used by vehicle 10 to provide detailed 3D spatial information for the identification of objects (e.g., the obstacle 12 of FIG. 1) near the vehicle 10, as well as the use of such information in the service of systems for vehicular mapping, navigation and autonomous operations. Radar systems and sonar systems may operate similarly to the LIDAR system (e.g., by calculating a time-of-flight to send and receive a signal) except use radio waves (e.g., waves in the electromagnetic spectrum) and sonic waves, respectively.

Referring to FIG. 2, the system 100 includes the network interface hardware 132 for communicatively coupling the system 100 with an external network. The network interface hardware 132 is coupled to the bus 136 such that the bus 136 communicatively couples the network interface hardware 132 to other modules of the system 100. The network interface hardware 132 may be any device capable of transmitting and/or receiving data via a wireless network. Accordingly, the network interface hardware 132 may include a communication transceiver for sending and/or receiving data according to any wireless communication standard. For example, the network interface hardware 132 may include a chipset (e.g., antenna, processors, processor-readable instructions, etc.) to communicate over wireless computer networks such as, for example, wireless fidelity (Wi-Fi), WiMax, Bluetooth®, IrDA, Wireless USB, Z-Wave, ZigBee, or the like. In some embodiments, the network interface hardware 132 includes a Bluetooth® transceiver that enables the system 100 to exchange information with an external network (e.g., a cellular network) or component (e.g., a smartphone) via Bluetooth® communication. In some embodiments, the network interface hardware 132 may be configured to connect to a vehicle-to-vehicle network (V2V), vehicle-to-infrastructure (V2I), or a vehicle-to-anything (V2X) network. Messages and other information may be passed between vehicles and infrastructure via such a network.

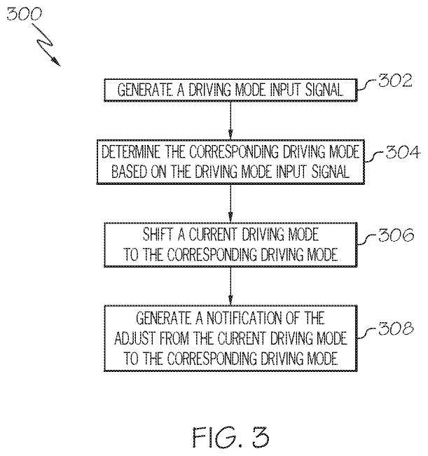

Referring now to FIG. 3, a method 300 for adapting a vehicle driving mode and a display based on a driving mode input adjustment is shown. While the particular embodiment shown in FIG. 3 depicts four steps, it is to be understood that embodiments may include more or fewer steps, including alternate steps to those shown. The method 300 may be executed based on instructions stored in the memory module 120 that are executed by the processor 118.

At block 302, the system 100 may generate a driving mode input signal. The driving mode input signal may generally be a trigger for determining whether or not to change a driving mode. The driving mode input signal may be generated by various components of the system 100 and may be processed by, for example, the bus 136. The driving mode input signal may be any type of signal capable of being read and processed by the processor 118 or modules or systems communicatively coupled with the processor 118.

In embodiments, the driving mode input signal may be a sensor signal generated by the camera 110. For example, the camera 110 may receive a visual signal of the external environment, including an image of a surface (e.g., texture, presence of constituents, etc.) and may send the signal to one or more other components of the system 100. For example, the camera 110 may send image data to the processor 118 and the processor 118 may process the image data using one or more image processing or image recognition algorithms as described herein. The image processing or recognition algorithms may be used, for example, to determine a composition of the surface of a roadway (e.g., concrete, asphalt, gravel, etc.). In some embodiments, the image data may be processed to determine a weather condition (e.g., precipitation condition). In some embodiments, the image data may be used to determine whether there is a foreign constituent on the road surface (e.g., ice, snow, water, mud, obstacles, etc.). In some embodiments, the system 100 may generate a confidence score related to the confidence with which the system 100 identifies a particular object or aspect of an image. For example, with brief reference to FIG. 1, the system 100 may capture an image of the obstacle 12 and may process the image to generate a confidence score of 99 (out of 100, for example) that the obstacle 12 is a rock. The system 100 may classify the object based on the confidence score and may take one or more of the actions described herein based on the classification of the obstacle 12. Referring to FIGS. 2 and 3, iln some embodiments, the driving mode input signal may be based on input from the pressure sensor 122. For example, if the tire pressure drops below a threshold value, this drop may indicate a decrease in temperature, a flat tire, or some other changing condition. The system 100 may adjust one or more aspects of the corresponding driving mode based on such a change. Additionally, the driving mode input signal may be based on an external or internal temperature as measured by the temperature detector 108. For example, if the temperature is below freezing, it may be more likely that ice is present on a driving surface. The driving mode input signal may be based on a signal from the temperature detector 108, for example, to change one or more aspects of the drive mode to account for temperature. Additionally, it is to be understood that any combination of signals from the sensors described herein can be combined, as well as with the other information described herein (e.g., information from an external weather server), into the driving mode input signal. In one possible example scenario, information from an external weather server may indicate that an hour ago the weather was forty-five degrees Fahrenheit and raining and a temperature sensed by the temperature detector 108 may indicate that it is currently below freezing. Accordingly, the system 100 may be configured to determine that ice is more likely and this information may be a factor in the driving mode input signal.

In some embodiments, the driving mode input signal may be based on a position, motion, and/or orientation of the vehicle 10 as determined by, for example, the clinometer 130 and/or the accelerometer 144. For example, with brief reference to FIG. 1, if the vehicle 10 drives over the obstacle 12 with the two left wheels of the vehicle 10, the vehicle 10 will have a different orientation than if all four wheels are flat on a surface (i.e., a roll to the right). The driving mode input signal may reflect such an orientation based on readings from the clinometer 130 and may adjust the corresponding driving mode accordingly. In embodiments, the system 100 may detect an aspect of vehicle position, motion, and/or orientation using the accelerometer 144 and may affect the driving mode input signal based thereon.

Additionally, the driving mode input signal may include information from an external server. For example, the driving mode input signal may include information about the surface of a road as received from the navigation module 124, which may be connected to an external server (e.g., a cloud server, the Internet, or the like). For example, the navigation module 124 may send a signal to the processor 118 that includes information about the composition of the surface of the road (e.g., that a particular road is paved with asphalt, concrete, gravel, or the like). This information may be used as an input to the driving mode input signal and may be used to change to a corresponding driving mode as described herein. For example, if it is known that a particular surface along a route is covered in gravel, it may be more likely for the driving mode to change while the vehicle 10 is operating on that surface. For example, it may be more or less likely for a four wheel drive setting to engage. In some embodiments, the driving mode input signal may automatically update as the vehicle 10 moves from place to place based on surface information as obtained by the navigation module. In some embodiments, the driving mode input signal may determine surface information along a route based on a preplanned route as determined by, for example, the navigation module 124. That is, a route may be planned from a first location to a second location and the system 100 may determine surface information for one or more of the segments between the first location and the second location. The surface information may include, for example, surface composition as well as grade, incline, and other information. The driving mode input signal may be determined based on this surface information. In some embodiments, the driving mode input signal may be based on a change between two consecutive segments along the route. As a non-limiting example, a driving mode input signal may be based on a change from a paved road (e.g., asphalt) to a non-paved road (e.g., gravel). In some embodiments, the driving mode input signal may include information about traffic (current and/or patterns) as received by, for example, the navigation module 124.

In some embodiments, the driving mode input signal may be based on a weather condition or an expected change in weather at a particular location (e.g., the location of a vehicle, the vehicle's destination, or the like) and/or along a preplanned route as determined by, for example, the navigation module 124. For example, if the vehicle 10 is in a parking lot where it is snowing, the system 100 may automatically adjust to a four-wheel-drive mode. As another example, if the system 100 determines that the vehicle 10 will be travelling from a first location to a second location and there are changes in weather along the route, the driving mode input signal may be based on these changes. Accordingly, one or more changes to the driving mode may be based on a change in weather along a route of the vehicle 10.

In some embodiments, the driving mode input signal may be based on a user input. For example, a user may use one or more of the input device 112, the microphone 138, and the camera 110 (e.g., using one or more gestures) to make an input to the system that may change one or more vehicle settings. Additionally, a driving mode input signal may be based on user preferences that may be learned over time. For example, the system 100 may use one or more machine learning algorithms to learn user preferences based on the way that a user normally prefers to operate his or her vehicle. Such preferences may be used to affect the driving mode input signal.

At block 304, the system 100 determines a corresponding driving mode based on the driving mode input signal. The corresponding driving mode is the driving mode that is most likely to result in a satisfactory vehicle response to a user's ordered vehicle actions. For example, if a user wants to drive the vehicle over mud, rocks, or debris, the corresponding driving mode is the driving mode that makes it most likely that a user can overcome the mud, rocks, or debris. As another example, if a user is operating the vehicle in snowy or icy conditions, the corresponding driving mode may be a driving mode that reduces the likelihood that the vehicle will lose traction in the snow or ice (e.g., the vehicle may engage four-wheel-drive, or the like). In some embodiments, the corresponding driving mode may be user-determined. For example, one or more components or aspects may be grouped into one or more driving mode profiles. The driving mode profiles may be stored and saved in a memory accessible by the system 100, for example, the memory module 120. In embodiments, a user may automatically adjust settings by selecting one of the driving mode profiles. In embodiments, the corresponding driving mode may maximize vehicle efficiency (e.g., miles-per-gallon), increase acceleration capacity, maximize top speed, reduce turn radius, or affect some other change to vehicle operation. The corresponding driving mode is configurable based on user input and can be changed based on user preferences and vehicle use. For example, a user may prefer to operate the vehicle 10 aggressively. One particular corresponding driving mode may be configured to adjust transmission shifting points to generally increase torque as the vehicle 10 accelerates (e.g., to allow the engine to reach a higher revolutions-per-minute in each subsequent gear as the vehicle accelerates, to activage one or more cylinders, or the like).

At block 306, the system adjusts a current driving mode to the corresponding driving mode. The driving mode adjustment may encompass altering one or more system or component settings from a current setting to a setting that is commensurate with the corresponding driving mode. The adjustment of multiple settings may occur simultaneously or in a sequential order or other order. In one example, the vehicle 10 may adjust from two-wheel-drive to four-wheel-drive or may activate a transmission cooler, for example. In some embodiments, the system 100 may deactivate various systems. For example, a traction control system may be deactivated. In some embodiments, signals that cause the adjustment may be generated by the processor 118 and may be distributed by the bus 136, which may be, for example, a CAN bus.

At block 308, the system generates a notification of the adjustment from the current driving mode to the corresponding driving mode. The notification of the adjustment from the current driving mode to the corresponding driving mode may be displayed, for example, on the display 104. Accordingly, the notification may be embodied visually as a static or dynamic symbol. In some embodiments, the notification may be audible. For example, the notification may be sounded over the speakers 140. Accordingly, the notification may be any static or dynamic audible signal. For example, the signal may be a chime, a ring, or other sound that indicates a system change to the user. Example embodiments of the notification of the adjustment will be described in greater detail herein.

In some embodiments, the notification of the adjustment to the corresponding driving mode may take place before the adjustment. For example, the notification of the adjustment may occur when the system 100 determines a corresponding driving mode for a particular segment in the future but the actual adjustment to the corresponding driving mode may not take place until the vehicle 10 has arrived at the road segment (or other off-road driving surface) in which the corresponding driving mode is better than the current driving mode. In some embodiments, the notification of the adjustment may include an opportunity for a user to prevent the adjustment in driving mode such that no adjustment in driving mode actually occurs if the user vetoes the adjustment. For example, a graphical user interface on the display 104 may include a “cancel” button or the like.

In some embodiments, the notification of the adjustment to the corresponding driving mode may include a reason for the adjustment. That is, the system 100 may generate some explanation as to why the vehicle 10 is adjusting from the current driving mode to the corresponding driving mode. For example, if the adjustment in driving mode is due to potentially inclement weather, the notification may include a message or other notification of the inclement weather in addition to the notification of the adjustment.

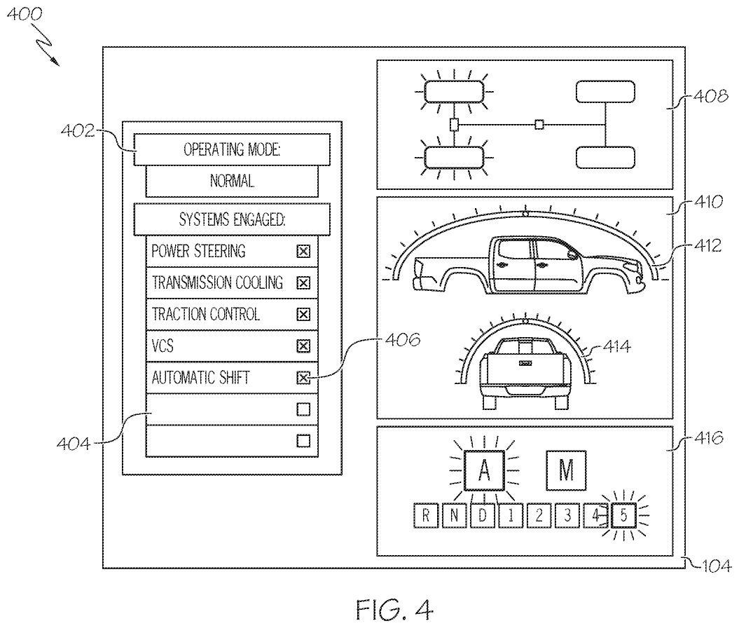

Referring now to FIG. 4, a graphical user interface (GUI) 400 for display on, for example, the display 104 (FIGS. 1 and 2) of the vehicle 10 is shown. The GUI 400 displays information about the current driving mode to a user of the vehicle. As shown in a systems status block 402 of the GUI 400, the system 100 is operating in a normal mode. Each of the systems listed in a systems engaged block 404 are engaged as indicated by the toggle box 406. The GUI 400 also shows various systems statuses using icons. For example, the GUI shows a drive train block 408 of the example vehicle that highlights the rear two wheels of the vehicle as an indication that the rear two wheels of the vehicle are powered and the vehicle is operating in a two-wheel-drive mode. A display clinometer 410 of the vehicle shows a pitch 412 and a roll 414 of the vehicle. The pitch 412 and the roll 414 may be determined by, for example, the clinometer 130 of FIG. 2. A transmission status box 416 shows that the transmission is currently in an automatic mode with the vehicle in a fifth gear. It is to be understood that the GUI 400 for the vehicle 10 shown in FIG. 4 is merely one exemplary embodiment and that other displays and/or GUIs may include different information.

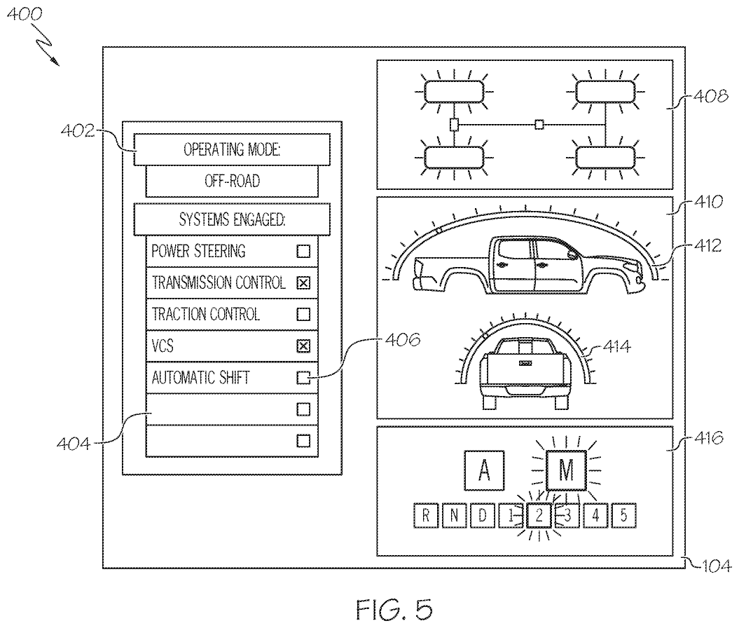

FIG. 5 shows an embodiment of the GUI 400 in which several of the vehicle settings have change due to an automatic adjustment as described herein. The GUI 400 in FIG. 5 shows a systems status block 402 that describes the current vehicle mode as “Off Road.” In the off road mode, some of the various systems shown in the systems engaged block 404 may toggle status. For example, the traction control system is shown as deactivated in the systems engaged block of FIG. 5. This is an indication to the user that the traction control system is no longer activated. Other systems are deactivated in the particular embodiment shown, for example, the power steering is shown as disengaged. Briefly referring to FIG. 1, the deactivation of the power steering system may indicate to a driver of the vehicle 10 that he needs to turn the steering wheel 102 more to turn the vehicle 10. Referring again to FIG. 5, the drive train block 408 indicates that all four wheels of the vehicle 10 are engaged to receive power and that the vehicle is operating in four-wheel-drive mode. The pitch 412 and roll 414 of the vehicle 10 are indicated by the display clinometer 410. As shown in FIG. 5, the vehicle has adjusted to a manual transmission shift mode and the vehicle 10 remains in fifth gear.

Referring now to FIGS. 1, 4, and 5, an exemplary scenario of the operation of the system 100 is shown and described. The particular example scenario shown in FIG. 1 shows the vehicle 10 approaching an area of poor weather due to snow and ice and the vehicle 10 is operating off road. Before the vehicle 10 arrives at the area of poor weather, it is in a normal operating mode as indicated by the GUI 400 shown in FIG. 4. The corresponding driving mode for normal operations may include operating in two-wheel-drive with each of the systems shown in the systems engaged block 404 activated. That is, for example, a traction control system may be engaged, a power steering system may be engaged, etc. The vehicle may be operating in an automatic transmission shifting mode that requires minimal user input to change gears.

However, as shown in FIG. 1, the vehicle 10 may approach a location where the weather changes to snowy or icy conditions (as indicated by precipitation 14) with one or more obstacles (such as the obstacle 12) in the path of the vehicle 10. As the weather changes, one or more systems or components on the vehicle 10 may determine the changing conditions and may generate a driving mode input signal based on the changed conditions. For example, in some embodiments, the vehicle 10 may use onboard sensors to determine the presence of the ice and/or snow (or other precipitation) using one or more of the temperature detector 108, the camera 110, or the pressure sensor 122. As shown in FIG. 1, the temperature is 31 degrees F. and there is snow falling. The camera 110 may be configured to recognize snow via one or more object classification or recognition algorithms and may generate a driving mode input signal based on this change. The temperature detector may detect the freezing temperature and generate a driving mode input signal based on the possibility that water on a driving surface (e.g., roads, bridges, etc.) may be frozen. If the air pressure of a tire changes significantly up or down (as determined by, for example, the pressure sensor 122 of FIG. 2), this may be an indication of a change in an external condition and such a change may be used to generate a driving mode input signal.

In some embodiments, the vehicle 10 may utilize other systems that may connect to one or more external systems or networks in order to determine environmental conditions. For example, the vehicle 10 may determine that icy/snowy conditions are possible via a web-based weather service that may be accessed via the network interface hardware 132. In some embodiments, weather information from a web-based weather service may be displayed on the display 104, for example, using the GUI 400. In yet other embodiments, the vehicle may determine external conditions based on an input received from the traction control system 146. For example, the traction control system 146 may activate which may indicate ice or snow on the road. In some embodiments, the system 100 may receive an input from the navigation module 124 that includes information about slow traffic in a particular area, which may indicate poor driving conditions, such as snow and ice. In some embodiments, the vehicle 10 may connect to other vehicles or to infrastructure in the area via a V2V, V2I, and/or V2X network and may receive updates on conditions via the V2V, V2I, and/or V2X network. Based on such a determination, the vehicle 10 may determine a corresponding driving mode based on the new conditions.

Still referring to FIGS. 1, 4, and 5, the system 100 may receive an input from the traction control system 126. For example, the traction control system 126 may generate a traction control signal based on a mismatch between a throttle input signal and/or an engine torque signal and a wheel response signal (e.g., if a wheel spins in icy, muddy, or other low-friction conditions). As shown between FIGS. 4 and 5, the vehicle 10 may update the display with the status of the traction control system to notify users of the adjustment in vehicle conditions.

Still referring to the scenario shown in FIG. 1, the vehicle 10 adjusts from the normal operating mode (as indicated by the GUI in FIG. 4) to the off-road operating mode (as indicated by the GUI in FIG. 5). When the adjustment occurs, the vehicle 10 engages four-wheel drive, shifts the transmission to manual-assisted mode, and disengages the power steering and the traction control system. The off-road mode may

In some embodiments of the system, the user may receive a notification of the adjustment via the speakers 140 and may acknowledge the notification or order one or more changes to the driving mode via a user input through one or more of the camera 110 (gesture or other visual cue), the input device 112 (tactile cue), and the microphone 138 (oral cue).

Accordingly, the display 104 may indicate the adjustmented status of one or more components or systems to the user as a notification that one or more of the systems have adjusted their status. The GUI in FIG. 5 shows the vehicle 10 as it drives over the obstacle 12 of FIG. 1. Accordingly, the pitch 412 and the roll 414 indicate the vehicle is off of centerline for both measurements. That is, the vehicle 10 is pitched backward and rolled the left as it drives over the obstacle 12. The vehicle 10 may change one or more vehicle settings based the input from the clinometer 130. For example, the vehicle 10 may disengage the drive input to the wheels on the left side of the vehicle 10 or to the wheels in the front of the vehicle 10 as the vehicle 10 drives over the obstacle.

In some embodiments, the driving mode input signal may change a transmission mode of the vehicle 10. For example, the transmission may be changed from an automatically shifting mode to a manually shifting mode or an automatically-assisted manually shifting mode in which the user can manually shift the transmission, but the transmission will automatically shift in the absence of user input.

In some embodiments, the system 100 may be configured to generate a request for user response to the notification of the adjustment to the corresponding driving mode. For example, the vehicle 10 may use one or more of the display 104 and the speakers 140 to request user feedback to the adjustment. For example, the system 100 may display a question to the user on the display such as, “Do you prefer the current operating mode?” The question may be posed along with one or more answers, for example, “Yes,” or “No.” In some embodiments, the question may be asked audibly, for example, the system 100 may ask, “The vehicle has adjusted to four-wheel drive, do you want to maintain the vehicle in four-wheel drive?” over the speakers 140.

The system 100 may be further configured to receive a user response (e.g., user input signal) to the notification of the adjustment to the corresponding driving mode. The user may generate a user input signal using, for example, the input device 112 and/or the display 104. In some embodiments, the user may generate a user input signal using the microphone 138. The system 100 may include one or more speech or other audible signal recognition algorithms for determining the signal.

In embodiments, the system 100 may adjust back to the first driving mode based on receiving a user response to the notification of the adjustment to the corresponding driving mode. For example, if the user responds negatively to a request for information as to the user's preference for the new settings, the system 100 may reset to one or more of the original settings.

It should now be understood that systems and methods for adapting a vehicle driving mode and a display may be based on a driving mode input signal. The driving mode input signal may be generated by one or more onboard systems or sensors and/or may be received from an external system or network. Based on the driving mode input signal, a vehicle may determine a corresponding driving mode and may adjust one or more vehicle settings from their current mode to the corresponding driving mode. That is, the one or more vehicle settings may be adjusted from a first mode to the corresponding driving mode. In embodiments, the system may notify the driver or other passengers of the vehicle that the adjustment has occurred, which may keep the driver and other passengers informed of vehicle settings and offer the opportunity to reverse changes to setpoints. Accordingly, vehicles using such systems and methods may enhance the vehicle operating experience for drivers and passengers of vehicles.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a processor; and
a memory module communicatively coupled to the processor, the memory module comprising one or more processor-readable instructions that, when executed, cause the processor to:
receive a driving mode input signal, the driving mode input signal corresponding to one or more driving conditions;
determine a corresponding driving mode based on the driving mode input signal;
adjust a first driving mode to the corresponding driving mode; and
generate a notification of the adjustment from the first driving mode to the corresponding driving mode.

2. The system of claim 1, further comprising a sensor configured to generate a sensor signal and wherein the driving mode input signal includes the sensor signal.

3. The system of claim 2, wherein the sensor is one or more of a camera, a temperature detector, a clinometer, and a pressure sensor.

4. The system of claim 1, further comprising a traction control system configured to generate a traction control signal corresponding to a condition causing a discrepancy between one or more of an engine torque, a throttle input, and a wheel response, wherein the driving mode input signal includes the traction control signal.

5. The system of claim 1, further comprising network interface hardware configured to connect to an external device and wherein the driving mode input signal is based on information received from the external device.

6. The system of claim 5, wherein the information received from the external device includes weather information.

7. The system of claim 1, wherein the notification is displayed via a graphical user interface.

8. The system of claim 7, further configured to:
generate a request for user response to the notification of the adjustment to the corresponding driving mode;
receive a user response to the notification of the adjustment to the corresponding driving mode, the user response indicating a request to remain in the first driving mode; and
adjust to the first driving mode based on receiving the user response.

9. The system of claim 1, further comprising a display and wherein a portion of the notification of the adjustment from the first driving mode to the corresponding driving mode is displayed on the display.

10. The system of claim 9, wherein the notification includes an indication of a reason for the adjustment.

11. A vehicle including a system comprising:
one or more vehicle-mounted sensors configured to generate a sensor signal that is based on one or more sensed driving conditions;
a processor; and
a memory module communicatively coupled to the processor, the memory module comprising one or more processor-readable instructions that, when executed cause the processor to:
receive a driving mode input signal, the driving mode input signal corresponding to one or more driving conditions and based on the sensor signal;
determine a corresponding driving mode based on the driving mode input signal;
adjust a first driving mode to the corresponding driving mode; and
generate a notification of the adjustment from the first driving mode to the corresponding driving mode.

12. The vehicle of claim 11, wherein the one or more sensors comprise one or more of a camera, a LIDAR system, a radar system, a temperature detector, a clinometer, an accelerometer, and a pressure sensor.

13. The vehicle of claim 12, wherein at least some portion of a vantage of the camera faces an interior of the vehicle and is configured to identify one or more occupants of the vehicle.

14. The vehicle of claim 11, further comprising a traction control system configured to generate a traction control signal corresponding to a condition causing a discrepancy between one or more of an engine torque, a throttle input, and a wheel response, wherein the driving mode input signal includes the traction control signal.

15. The vehicle of claim 11, further comprising network interface hardware configured to connect to an external device and wherein the driving mode input signal is based on information received from the external device.

16. The vehicle of claim 15, wherein the information received from the external device includes weather information.

17. The vehicle of claim 11, wherein the vehicle is further configured to:
generate a request for user response to the notification of the adjustment to the corresponding driving mode;
receive a user response to the notification of the adjustment to the corresponding driving mode, the user response indicating a request to remain in the first driving mode; and
adjust back to the first driving mode based on receiving the user response.

18. A method of adjusting a vehicle driving mode to a corresponding driving mode, the method comprising:
receiving, by a processor, a driving mode input signal, the driving mode input signal corresponding to one or more driving conditions;
determining, by the processor, a corresponding driving mode based on the driving mode input signal;
adjusting, by the processor, a first driving mode to the corresponding driving mode; and
generating, by the processor, a notification of the adjustment from the first driving mode to the corresponding driving mode.

19. The method of claim 18, further comprising generating a sensor signal using a sensor and wherein the driving mode input signal includes the sensor signal.

20. The method of claim 18, further comprising receiving, by the processor, weather information from an external device and wherein the driving mode input signal is based on the weather information.
